(19) United States
(12) Patent Application Publication
(10) Pub. No.: US 2026/0236569 A1
(43) Pub. Date: Aug. 13, 2026

(54) CONFIGURABLE VEHICLE AUTHORIZATION USING LOCAL BIOMETRIC AUTHENTICATION

(71) Applicant: CERENCE OPERATING COMPANY, Burlington, MA (US)

(72) Inventors: Alexandre Boudreau, Burlington, MA (US); Khaled Anani, Burlington, MA (US)

(21) Appl. No.: 19/156,191

(22) PCT Filed: Feb. 14, 2023
(86) PCT No.: PCT/US2023/013000

§ 371 Date: Aug. 13, 2025

(51) Int. Cl. G06F 21/32

(52) U.S. Cl. CPC G06F 21/32

(57) ABSTRACT

A biometric authenticator for use by an application executing on a vehicle's infotainment system carries out a biometric authentication procedure that is tailored to dynamically varying context information that is obtained by vehicle sensors.

### BACKGROUND

It has become increasingly common for software applications to carry out sensitive tasks. In such cases, it is useful for the application to know, before carrying out that task, that the person requesting that the task be carried out is not an impostor. In other words, it is useful to be able to authenticate the person.

One way to detect an impostor is to request a password. Alternatives include requesting information that is unlikely to be known by a mere impostor.

These methods have certain flaws. Passwords can be guessed. And when the impostor knows the person well enough, the impostor may know the purportedly secret information just as well as the real person.

These flaws can be overcome, to some extent, by relying on actual physical features of the person. Examples include inspecting a fingerprint, analyzing a voice print, or carrying out facial recognition. This type of authentication is often referred to as “biometric” authentication.

### SUMMARY

A human being has certain physical features that are useful for biometric authentication. For the most part, these are features that human beings use to recognize each other. Such features include spoken voice and facial features.

The set of all such physical features shall be referred to herein as the human's “biometric feature set.” Each element of the set shall be referred to as a “biometric feature.” A “biometric authentication mode” shall refer to the use of a subset of the biometric feature set for biometric authentication. That subset defines the “biometric badge.” Embodiments include those in which the subset consists of one biometric feature and those in which it consists of two or more biometric features in combination. Examples of biometric authentication modes include the use of voice identification, facial recognition, fingerprints, features found on an iris, and the composition of a volatilome.

A modern motor vehicle is typically equipped with one or more sensors, such as microphones, which are often used in speech recognition systems, cameras, from which a driver's state of alertness can be estimated, and weight detectors on seats, such as those used to control seat belt warnings. It is possible to use outputs from these sensors to receive information concerning elements of the foregoing biometric feature set.

A typical vehicle also includes an “infotainment system” that can, among other things, execute software applications. These applications are often called upon to carry out tasks that are sufficiently sensitive in nature that detecting impostors would be useful. Whether or not an application takes steps to identify impostors is set forth in an “authentication policy” for that application.

An “authentication policy” defines the authentication procedure to be carried out by that application under a particular set of circumstances. An example of an authentication policy is one that depends on the particular user seeking authentication.

Another example is a policy that depends on the particular vehicle on which the application is executing. This is particularly useful for defining an authentication policy that is applicable to plural vehicles.

The invention provides a biometric authenticator that receives information from the foregoing sensors and uses that information to carry out biometric authentication. The invention is based in part on the recognition that the optimal biometric authentication procedure in a vehicle may change as circumstances change. Accordingly, it is advantageous to move away from rigidly defined authentication policies to permit variations that adapt to the circumstances unique to the vehicle's current state.

The biometric authenticator described and claimed herein adaptively orchestrates the use of such sensors to authenticate a transaction in different ways depending on the circumstances that the vehicle finds itself in from moment to moment. Moreover, the biometric authenticator does so in a manner that conforms to the changing circumstances within the vehicle subject to the constraints imposed by an authentication policy that defines the requirements of that transaction.

Such a system provides a more secure in-car user experience with streamlined authorization of external services, and in particular, simplified payment flows. It does so by leveraging local and secure biometric authentication, local and secure data storage, and remote configuration capabilities via a cloud-based management service.

In one aspect, a biometric authenticator includes a vehicular component and a remote component.

The authenticator's vehicular component comprises an embedded application that executes in an infotainment system that has been installed in an automobile. This vehicular component supports multiple biometric authentication modes. These biometric authentication modes are usable independently or in combinations. The vehicular component chooses a biometric authentication mode based on an authentication policy.

The authenticator's remote component is typically a cloud-based management service that is remotely configurable to enable one to configure one or more authentication policies.

The local component retrieves authentication policies from the remote component in a secure manner. It does so by using secure application program interfaces that use asymmetric encryption, tokens, and/or other security challenges. Doing so reduces the risk of having an unauthorized system or an unauthorized user change the biometric authenticator's configuration and policies.

The vehicular component provides secure biometric authentication that is usable by other applications that are executing in the infotainment system.

An application that executes an infotainment system will in some cases attempt to execute its own authentication process, or “authentication flow.” Among the services provided to the vehicular component of the authenticator is that of simplifying this authentication flow. In some embodiments, the vehicular component does so by storing a user's credentials under biometric lock. In others, it does so by providing password-free authentication with compatible services.

The biometric authenticator also provides a secure storage area for securely storing biometric information to be used as biometric user credentials required by one or more other applications that execute on the infotainment system. This biometric information is securely and separately stored within the infotainment system separately from application data and from non-biometric user credentials associated with that application.

The biometric authenticator stores these credentials using a specific application program interface. Once securely stored, the credentials are retrievable only by using the specified user's biometric information or a specified backup authentication method, if applicable.

When required by an authentication policy, the biometric authenticator executes a non-biometric authentication process in addition to the biometric authentication process. In some embodiments, the process of first enrolling a user includes pairing a non-biometric external factor, an example of which is a smartphone, with the user. This further promotes security. In such cases, success in authentication requires both the presence of the external security factor and consistency between measured biometric information and stored biometric information.

Other embodiments include local access policies that specify which of the applications executing in the vehicle's infotainment system are permitted to use the biometric authenticator or are required to use the biometric authenticator and what level of security is required, in either case. Examples include local access policies that specify which biometric authentication mode to use and whether or not authentication requires an external security factor. In some cases, such policies specify which users from a set of candidate users can or should use the biometric authenticator. In one embodiment, the manufacturer of the vehicle defines which application can or should use the biometric authenticator for a streamlined user experience. In another embodiment, a company, such as that which owns or maintains a fleet of vehicles, specifies, for each vehicle in a fleet of vehicles, what specific applications require biometric authentication and for which users such authentication is required.

In a preferred embodiment, the biometric authenticator implements pre-designed and developed speech dialogs that guide a user through the authentication flow. The dialog used depends on the particular biometric authentication mode that is being used.

In one aspect, the invention features a method of using a vehicle's infotainment system to control an application's ability to perform a task that an occupant of the vehicle has asked the application to perform. This application is one of possibly several that are executing on the infotainment system.

In some cases, the application is prevented from performing the task. In others, it is permitted to perform the task. Which of these possibilities materializes depends on the outcome of a biometric authentication procedure.

The nature of this biometric procedure is far from static. It depends on dynamically varying context information. The nature of the biometric procedure thus varies depending on the circumstances. This enables tailoring the biometric authentication procedure to suit the particular circumstances that are present at the time that the biometric authentication is taking place. Thus, it is quite possible for identical applications that have been asked to do the same task to nevertheless require different biometric authentication procedures.

The method described and claimed herein is one that includes executing a vehicular component of a biometric authenticator on the infotainment system, executing a remote component of the biometric authenticator on a processing system other than the infotainment system, and providing data communication between the biometric authenticator's local component and remote component.

The method continues with executing the application on the infotainment system, the application having been asked, by the occupant, to perform the task. This is followed by retrieving, at the biometric authenticator's local component, an authentication policy that originated at the biometric authenticator's remote component. This authentication policy specifies an authentication procedure that is to be executed by the application for authenticating the occupant. Successful authentication of the occupant is a prerequisite for performing the task. The method further includes determining that the authentication procedure requires biometric authentication.

The method further continues with receiving information indicative of a dynamically varying context. This information is derived from information concerning a state of the vehicle. Once this information is available, the method continues by modifying the authentication procedure based on the context and carrying out biometric authentication of an occupant of the vehicle using the authentication procedure as modified based on the context. Finally, a determination is made concerning whether or not the biometric authentication procedure authenticated the occupant's identity and the application is notified accordingly. If the authentication was successful, the application performs the task. Otherwise, it does not.

Among the practices of the invention are those in which modifying the authentication procedure based on the context includes determining that the authentication procedure requires measurement of a first biometric feature and replacing the measurement of the first biometric feature with a measurement of a second biometric feature.

Also among the practices of the invention are those in which modifying the authentication procedure based on the context includes selecting a biometric feature to rely upon for authentication based at least in part on the context.

Still other practices include those that include replacing a measurement made by a camera with a measurement made by a microphone and those that include replacing a measurement made by a microphone with a measurement made by a camera. More generally, the authentication procedure is modified to increase the probability of correct authentication given the existence of particular context information.

In still other practices, the authentication procedure includes deselecting a biometric feature that would otherwise have been relied upon for authentication based having determined that the context would make reliance on such a biometric feature unsatisfactory. For example, in some cases, a light level within a cabin of the vehicle is insufficient to use a particular biometric feature as a basis for the authentication.

Alternatively, the noise level within the cabin may be too high to permit using a particular biometric feature as a basis for authentication.

In some practices, the context includes a kinematic property of the vehicle, such as its acceleration vector, its velocity vector, or its position vector. Among these practices are those in which modifying the authentication procedure includes deselecting a biometric feature to rely upon for authentication based on a direction in which the vehicle is traveling and those in which modifying the authentication procedure includes deselecting a biometric feature to rely upon for authentication based on a velocity of the vehicle.

In some cases, the process of actually acquiring the necessary biometric information requires cooperation by the occupant. For example, an occupant may need to face a particular camera or execute a particular utterance. In such embodiments, carrying out biometric authentication of the occupant includes causing a dialog manager to engage in an interactive dialog with the occupant to guide the occupant in providing biometric information for use in the biometric authentication.

In some cases, the authentication procedure depends on the nature of the occupant who is seeking authentication. For example, some practices include those in which modifying the authentication procedure includes modifying the procedure based on having determined that the occupant seeking authentication is a passenger in the vehicle.

Still other practices include causing the vehicular component of the biometric authenticator to orchestrate sensors in the vehicle to gather different types of biometric information in response to changing circumstances that arise during operation of the vehicle.

In yet other practices, modifying the authentication procedure based on the context further includes causing the vehicular component of the biometric authenticator to define a biometric badge for use as a basis for biometric authentication, the biometric badge being based on different types of biometric information that have been assigned weights based on context information obtained from sensors in the vehicle.

Also among the practices are those in which modifying the authentication procedure based on the context includes defining a dynamically varying biometric badge for use as a basis for biometric authentication, the dynamically varying biometric badge being a superposition of different sources of biometric information with the superposition having been selected based on context information.

A variety of tasks are contemplated for the application to be asked to perform. Among these are practices in which the task is a payment and those in which the task is to operate an apparatus external to the vehicle, such as opening a garage door, opening a residential door, or operating a suitably enabled residential appliance.

Still other practices include receiving, at the remote component, an instruction to modify an authentication policy.

Some embodiments include maintaining a plurality of authentication policies at the remote component. Among these are policies that are applicable to only a first fleet of vehicles, policies that are applicable to a second fleet of vehicles, policies that are appliable to particular sets of occupants, policies that are applicable only at particular geographic locations and not in others, and policies that are only applicable at some intervals of time and not in others.

In another aspect, the invention features an apparatus including an infotainment system in a vehicle. The infotainment system is configured to control an application's ability to perform a task that has been requested by an occupant of the vehicle. In some cases, the apparatus prevents the task from being carried out and in other cases it permits the task to be carried out. Which of these occurs depends on an outcome of carrying out biometric authentication of the occupant.

The apparatus includes a biometric authenticator having a vehicular component and a remote component. The vehicular component, which executes on the infotainment system, is in data communication with the biometric authentication system's remote component The remote component executes on a processing system other than the infotainment system.

The apparatus further includes a policy store that stores authentication policies that have been retrieved from the remote component. Each of the authentication policies specifies an authentication procedure for authenticating an occupant of the vehicle. A successful biometric authentication procedure is a pre-requisite for performing the task that the application has been asked to perform.

The apparatus further includes a context source that provides, to the vehicular component of the biometric authenticator, dynamically varying context. This context is derived from information concerning a state of the vehicle. The biometric authenticator's local component is configured to modify one or more of the authentication procedures in response to the dynamically varying context, to attempt to biometrically authenticate the occupant of the vehicle based on the authentication procedure, and to notify the application that an attempt to biometrically authenticate the occupant of the vehicle has failed or that it has succeeded.

In another aspect, the invention features a method for using an application executing on an infotainment system of a vehicle that includes receiving, from the application, information indicating that an occupant of the vehicle has requested performance of a task, selecting a first policy from a plurality of policies, each of which corresponds to a different task, the first policy defining a first biometric authentication procedure that is specific to the task, generating a second policy based on the first policy, using the second policy, carrying out biometric authentication of the occupant, and based on a result of the biometric authentication, authorizing performance of the task. The second policy defines a second biometric authentication procedure that differs from the first biometric authentication procedure.

Among the practices of the foregoing method are those in which generating the second policy comprises modifying the first policy based on context information, wherein the context information is indicative of a state of the vehicle, those in which generating the second policy comprises determining that the first policy requires measurement of a first biometric feature and using a measurement of a second biometric feature in the second policy, and those in which generating the second policy comprises selecting a biometric feature to rely upon for authentication in the second policy based at least in part on context information indicative of a state of the vehicle.

Further practices include those in which the policies are stored on a remote server.

Still other practices include those in which the first policy requires biometric authentication using a first method selected from the group consisting of facial recognition and voice recognition and generating the second policy comprises causing the second policy to require biometric authentication using a second method selected from the group consisting of facial recognition and voice recognition, the second method being different from the first method.

Other practices include those in which generating the second policy comprises determining that a light level within a cabin of the vehicle is insufficient to use a biometric feature relied upon in the first policy as a basis for the authentication and those in which generating the second policy comprises determining that too much noise is present to use a biometric feature relied upon by the first policy.

Still other practices include those in which generating the second policy comprises selecting a biometric feature to rely upon for authentication in the second policy based on a direction in which the vehicle is traveling, a magnitude of the vehicle's velocity, or the vehicle's velocity vector.

In other practices, carrying out biometric authentication of the occupant comprises causing a dialog manager to engage in an interactive dialog with the occupant to guide the occupant in providing biometric information for use in the biometric authentication.

Also among the practices of the invention are those in which generating the second policy comprises modifying the first biometric authentication procedure based on having determined that the occupant seeking authentication is a passenger in the vehicle, those in which generating the second policy comprises orchestrating sensors in the vehicle to gather different types of biometric information in response to changing circumstances that arise during operation of the vehicle, those in which generating the second policy comprises defining a biometric badge for use as a basis for biometric authentication in the second policy, the biometric badge being based on different types of biometric information that have been assigned weights based on context information obtained from sensors in the vehicle, and those in which generating the second policy comprises defining a dynamically varying biometric badge for use as a basis for biometric authentication in the second policy, the dynamically varying badge being a superposition of different sources of biometric information, wherein the superposition is selected based on context information, and those in which generating the second policy includes modifying the first policy based on how many occupants are in the vehicle.

A variety of tasks are contemplated. Among these are tasks that include transfer of a resource from a first location to a second location. Examples of resources include financial resources and resources that have value. Also among the tasks contemplated are those that include operating a device that is external to the vehicle.

Still other practices include receiving, at the remote component, an instruction to modify an authentication policy.

Still other practices include maintaining a plurality of authentication policies at the remote component. These include policies applicable to only a first fleet of vehicles, policies that are applicable to a second fleet of vehicles, the second fleet being different from the first fleet, policies that are appliable to particular sets of occupants, policies that are applicable only at particular geographic locations and not in others, and policies that are only applicable at some intervals of time and not in others.

In another aspect, the invention features a biometric authenticator that is in data communication with an application executing on an infotainment system of a vehicle.

The biometric authenticator comprises a vehicular component that executes on the infotainment system and a remote component that executes on a remote server. The biometric authenticator further comprises a policy store that stores authentication policies, each of which corresponds to a different task. The policies include a first policy that defines a first biometric authentication procedure that is specific to a first task. The biometric authenticator is configured to generate a second policy based on the first policy and to carry out biometric authentication of an occupant of the vehicle, the occupant having requested execution of the first task. The biometric authenticator is further configured to use the second policy to carry out biometric authentication of the occupant and, based on a result of the biometric authentication, to authorize performance of the first task. This second policy defines a second biometric authentication procedure that differs from the first biometric authentication procedure.

In yet another aspect, the invention features executing first and second instances of an application in infotainment systems of corresponding first and second vehicles. The first and second instances of the application have been requested, by corresponding occupants in the vehicles, to perform corresponding first and second identical tasks. The method further comprises causing the first instance of the application to carry out a first biometric authentication procedure to authenticate the first occupant and causing the second instance of the application to carry out a second biometric authentication procedure to authenticate the second occupant. The first and second biometric authentication procedures differ from each other as a result of the first and second vehicles being in different states. These different states give rise to corresponding differences in context information for the first and second vehicles.

All methods and systems described herein are non-abstract implementations. Descriptions of abstract implementations have been omitted. All claims, when properly construed, cover only non-abstract implementations. Applicant, acting as his own lexicographer, hereby defines “non-abstract” to be the converse or complement of “abstract” as that term has been construed by the courts of the United States as of the filing date of this application. Any person who construes the claims as covering abstract implementations would merely be proving that it is possible for a person to fail to construe the claims in light of the specification as required by law.

These and other features of the invention will be apparent from the following detailed description and the accompanying figures, in which:

### DESCRIPTION OF DRAWINGS

FIG. 1 shows constituents of a biometric authenticator;

FIG. 2 shows implementation of a transaction by the biometric authenticator of FIG. 1;

FIG. 3 shows steps carried out in a user's enrollment to use the biometric authenticator of FIG. 1;

FIG. 4 shows steps carried out by the biometric authenticator of FIG. 1 during authentication;

FIG. 5 shows steps carried out when an application manages a biometric lock for secure storage of credentials;

FIG. 6 shows credential management steps undertaken by the vehicular component for enabling an application to carry out biometric authentication;

FIG. 7 shows the biometric authenticator of FIG. 1 being used to access certain credentials;

FIG. 8 shows operation of the biometric authenticator of FIG. 1 interacting with an automotive assistant; and

FIG. 9 shows a process that follows a user's initiation of the application in FIG. 1.

### DETAILED DESCRIPTION

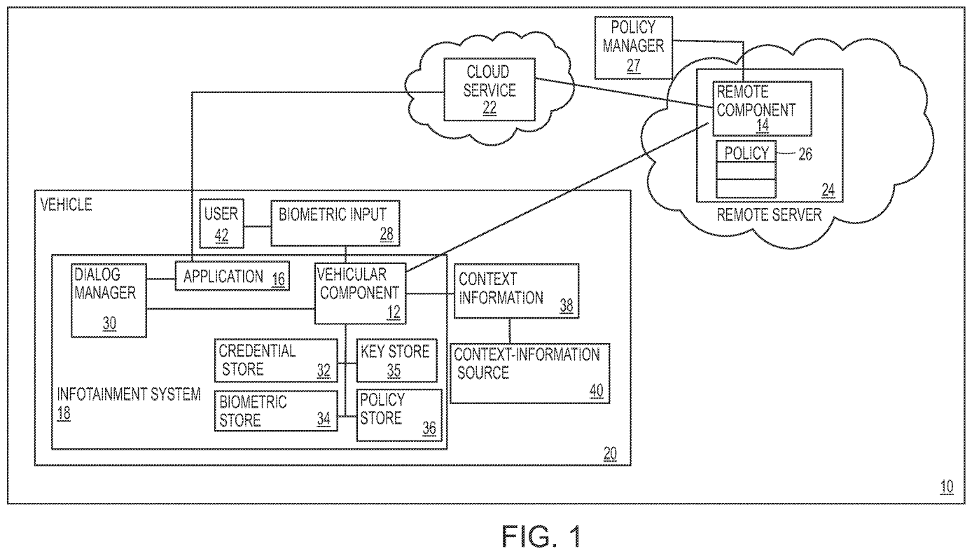

FIG. 1 shows a biometric authenticator 10 having a vehicular component 12 and a remote component 14. The vehicular component 12, along with one or more applications 16, executes on an infotainment system 18 within a motor vehicle 20.

In many cases, an application 16 executing on the infotainment system 18 is in wireless communication with a corresponding cloud service 22. The cloud service 22 facilitates the application's ability to carry out the technical effect of two-way communication certain information that is used to carry out certain tasks. Such tasks include those of both commercial and non-commercial nature, including the consummation of certain transactions, such as payment transactions and the operation of certain hardware fixtures. The application 16 provides the cloud service 22 with certain information to permit secure interaction therewith. Such information includes user credentials, information for carrying out password-free authentication, or information used to execute another authentication method expected by the cloud service 22.

The biometric authenticator's remote component 14 executes on a cloud-based server 24 that is in wireless communication with the infotainment system 18. An interface between the remote component 14 and the vehicular component 12 permits the local component 12 to achieve the technical effect of retrieving authentication policies 26 and/or configuration information for the vehicle 20 or one or more users thereof and also permits the remote component 14 to receive telemetry information from the local component 12.

The remote component 14 specifies policies 26 for use of the biometric authenticator 10. Such policies 26 include those that specify when the biometric authenticator 10 is to be used, those that specify how it is to be used, and combinations thereof. A human policy manager 27 communicates with the remote component 14 to set the various policies 26. The vehicular component 12 receives new policies or updates for existing policies and stores them in a policy store 36 within the vehicle 20.

In some examples, an authentication policy 26 requires an application 16 to always use the biometric authenticator 10. In other examples, the authentication policy 26 requires use of the biometric authenticator 10 for authentication requests originating from one or more vehicles 20 or all vehicles from a fleet of vehicles 20. In other examples, the authentication policy 26 requires that the biometric authenticator 10 be used for all authentication requests originating from a particular person or group of persons.

Examples of specifying how the biometric authenticator 10 is to be used include specifying the type of authentication to be used. For example, some authentication policies 26 require the use of facial recognition, others may require voice-print identification, and yet others may require some combination thereof.

Still other examples of specifying how the biometric authenticator 10 is to be used include setting particular confidence thresholds or specifying whether an external security factor should be used in conjunction with the biometric authenticator 10 and the nature of that security factor.

A typical authentication policy 26 includes information on who the policy 26 applies to. For example, a particular authentication policy 26 that applies to one vehicle 20 may differ from that applied to another vehicle. In some cases, a single authentication policy 26 applies to all vehicles 20 in a fleet of vehicles. The authentication policy 26 also specifies a type of transaction that it applies to. For example, a policy 26 for purchase of gasoline may differ from a policy 26 used for approval of an engine overhaul. The authentication policy 26 then identifies the authentication method and whether or not biometric authentication is required.

In addition to maintaining authentication policies 26, the remote component 14 carries out certain monitoring tasks. Examples of such tasks include collecting usage statistics and telemetry information. Such information indicates how many vehicles 20 have used the biometric authenticator 10 and the circumstances of each such use. Other information collected by the remote component 14 includes statistics indicative of success or failure rates of authentication attempts. Such information is useful for identifying particular vehicles with high rates of biometric authentication failure and thus, information concerning impostor attacks in which particular vehicles 20 are being targeted.

The various sensors with which a vehicle 20 is equipped are collectively referred to as a “biometric input 28.” The various constituent sensors of the biometric input 28 provide biometric information for use in authentication. Examples of such signals include those received from a microphone, those received from a camera, and those received from a sensor, examples of which include haptic sensors, infrared sensors, and sensors that receive energy and convert it into electrical energy.

Because the biometric input 28 provides multiple sources of biometric information, it is possible to pick and choose which biometric information should be used. The biometric information that is actually used for authentication is referred to as the “biometric badge.” The “biometric badge” is therefore that subset of the information available at the biometric input 28 that is made available to the biometric authenticator 10. In some embodiments, the subset is a proper subset. In others, it is not a proper subset.

The application 16 and the vehicular component 12 interface with a dialog manager 30, which executes either in the infotainment system 10 as shown or on the remote server 24. In response to an authentication request, the dialog manager 30 initiates an appropriate dialog to guide the user through the authentication flow. The authentication flow, and hence the appropriate dialog, depends on the nature of the authentication request, the vehicle's state, and any constraints imposed by the relevant authentication policy 26.

An authentication policy 26 is applicable to both unidentified users and to identified users, such as those that have been logged in. In some cases, an authentication policy 26 also extends to specific users. The authentication policy 26 determines the authentication procedure for each of these different classes of users. In doing so, it also relies on additional context. This context is obtained based on the vehicle's state.

As an example, for some authentication flows, it may be desirable to have the user utter a particular phrase indicative of that user's intent. Under such circumstances, the dialog manager 30 prompts the user to learn what the user's intent might be. This can be carried out through analysis of context or by asking the user to utter that particular phrase. In other cases the authentication flow may require some other activity by the user. As an example, if facial recognition is required, the dialog manager 30 may prompt the user by saying, “Please turn right and look into the camera until the light stops flashing.”

In addition, the application 16 and the vehicular component 12 interface directly with each other to permit retrieval of authentication status, policy information, and user credentials. Such information is available as a result of an interface between the vehicular component 12 and a credential store 32, a biometric store 34, a key store 35, and the aforementioned policy store 36. The credential store 32 stores user credentials from applications 16 that use biometric authentication. The biometric store 34 stores actual biometric information, such as voice prints, and does so separately from other storage. The key store 35 stores private keys. The policy store 36 stores authentication policies 26 associated with the particular vehicle 20 and/or one or more particular users 42.

The vehicular component 12 further includes access to context information 38. This context information 38 is indicative of the current state of the vehicle 20 and its environment as inferred from information provided by a context-information source 40. Examples of a context-information source 40 include information provided by the biometric input 28 and information from such other devices as a clock, a GPS device, a photosensor, a noise sensor, a meteorological sensor, and combinations thereof. Context information 38 includes both the activity of vehicle 20, e.g., its position and velocity, the population within the vehicle 20, and the vehicle's external environment, e.g., whether it is day or night, raining or clear.

The vehicular component 12 relies on this context information 38 as a basis for dynamically modifying the biometric badge based on changing circumstances. In some practices, the vehicular component 12 modifies the authentication procedure based on the vehicle's external environment.

In one example, context information 38 indicates that it is nighttime in the vehicle's environment. The vehicular component 12 infers that facial recognition is likely to be unreliable under low light conditions. A policy 26 indicates that the biometric badge should include information resulting from facial recognition. Nevertheless, the vehicular component 12 recognizes that low light conditions are not conducive to accurate facial identification. Accordingly, the vehicular component 12 effectively overrules the policy 26 by adaptively changing the requirements of the biometric badge to instead use something more reliable in low light conditions, such as a voice print

In some practices, the vehicular component 12 changes the nature of the biometric badge in response to the vehicle's activity.

In one example, context information 38 indicates that the vehicle 20 is moving backwards, for example while parallel parking. The vehicular component 12 infers that the driver is facing backwards and therefore not visible to a conveniently located camera. A policy 26 indicates that the biometric badge rely on information from facial recognition for authentication. In recognition of the likelihood that the user is facing the wrong way during such motion, the vehicular component 12 overrules the policy 26 and uses a biometric badge that relies on a voice print instead of on facial recognition.

In another example, the context information 38 indicates that the vehicle's environment is noisy. A policy 26 specifies that the biometric badge comprise a voice print. Under such circumstances, the vehicular component 12 overrules the use of a biometric badge that relies on a voiceprint. Instead, the vehicular component 12 modifies the biometric badge so that it relies on information that is more reliable under noisy conditions, such as facial recognition.

In yet another example, the context information 38 indicates that authentication is being sought by a passenger rather than a driver. As a result, the authentication procedure need not be constrained by the need to avoid excessively drawing on the driver's attention. Accordingly, the vehicular component 12 overrules an authentication procedure specified in a policy 26 to take advantage of this opportunity to use an authentication procedure that would not otherwise be available.

These examples suggest that the vehicular component 12 functions as a sensor orchestrator that directs the activity of different sensors that comprise the biometric input 28 in response to changing circumstances. This sensor orchestration results in the appropriate biometric badge that has been tailor made to suit the context in which the vehicle 20 finds itself.

As described in the foregoing examples, the vehicular component 12 constructs the biometric badge by enabling one sensor (e.g., a camera or microphone) and disabling others. However, this can be seen as a limiting case of constructing the biometric badge by using a weighted sum of sensor outputs in which only one sensor has a non-zero weight. In principle, it is possible to construct the biometric badge that comprises a weighted sum of information from different sources in which, in some limiting cases, some weights are set to zero. This results in a dynamically varying biometric badge that is a superposition of different sources of biometric information with the particular superposition being selected based on context information 38 derived from the context-information source 40.

In some embodiments, the result of successful authentication is consummation of a commercial transaction. However, it is also possible for successful authentication to result in some other activity, such as the unlocking of certain data that has been encrypted and stored within the vehicle 20 or the execution of certain commands, like opening a garage door.

In general, a user 42 interacts with an application 16 to perform some action that requires authentication. The application 16 obtains the relevant authentication policy for that action from the vehicular component 12. Having determined the relevant policy 26, the application 16 then uses the dialog manager 30 to initiate a dialog that prompts the user 42 to carry out certain actions that comply with that policy 26. The user 42 then provides the relevant biometric information. Ultimately, the application 16 makes a decision, based at least in part on the outcome of the biometric authentication, on whether or not the action should be permitted.

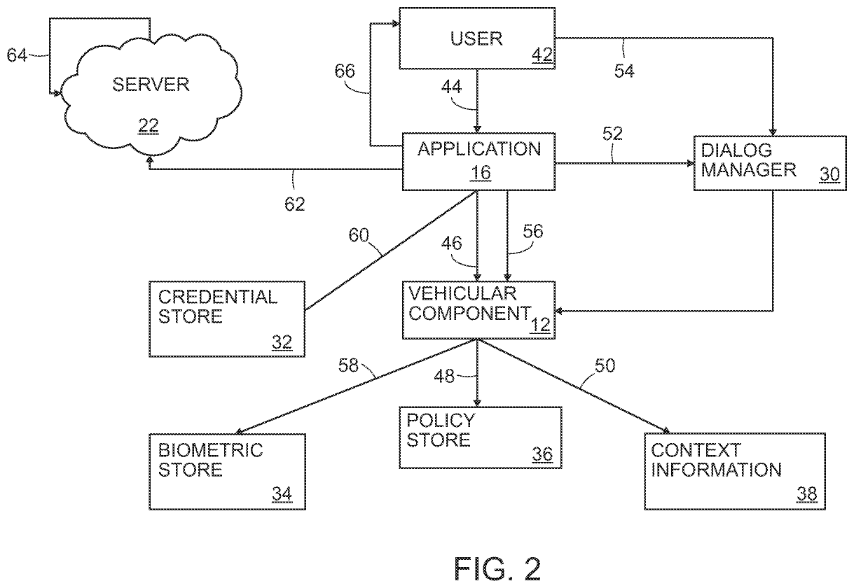

FIG. 2 shows the use of the biometric authenticator 10 in connection with a particular task.

The process begins with the user 42 who opens or otherwise initiates the application 16 (step 44). The application 16 then communicates with the biometric authenticator's vehicular component 12 (step 46). The vehicular component 12 inspects the policy store 36 to identify the appropriate policy for the requested task (step 48) and to confirm that, indeed, biometric authentication is required for this type of task. In addition, the vehicular component 12 inspects the context information 38 to determine whether the policy 26 should be modified (step 50).

Assuming that the policy 26 requires biometric authentication of the user's voice and that the vehicle 20 does, in fact, have a microphone for receiving the user's voice, the vehicular component 12 communicates the requirement for a voice sample back to the application 16.

The application 16 then causes the dialog manager 30 to instruct the user 42 concerning acquisition of relevant biometric information for constructing the biometric badge (step 52). In response, the user 42 provides the relevant biometric information (step 54) and any confirmatory utterances that may be required by the relevant policy.

The relevant biometric information is provided to the vehicular component 12, which attempts to verify the user's identity (step 56), for example by matching the biometric information provided with stored biometric information in the biometric store 34 (step 58).

The application 16 proceeds to retrieve user credentials (step 60) and to then send a payment request to the cloud service 22 (step 62). If all goes well, the cloud service 22 will authorize the payment (step 64). Upon learning of a successful authorization, the application 16 communicates this fact to the user 42 (step 66).

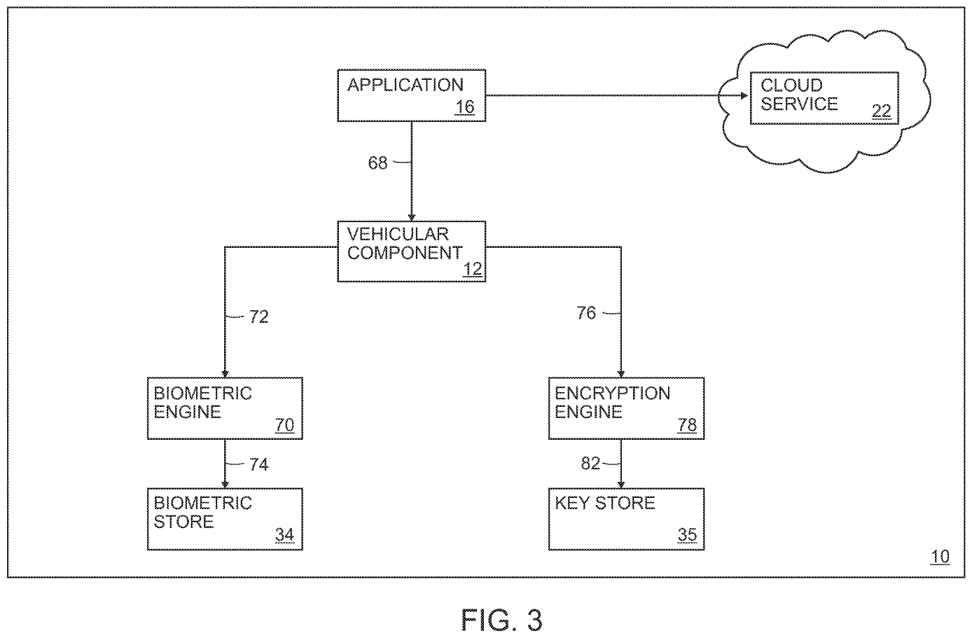

Before using the biometric authenticator 10, a user 42 uses the application 16 to enroll. As shown in FIG. 3, the application 16 communicates with the vehicular component 12 to enroll a particular user 42 for biometric authentication (step 68). In response, the vehicular component 12 launches a biometric engine 70 (step 72). The biometric engine 70 collects the relevant biometric information and stores a corresponding biometric print in the biometric store 34 (step 74).

The vehicular component 12 then causes the encryption engine 78 to create a private key for the user 42 (step 76), which it then stores in a key store 35 (step 82).

In an alternative practice, the process described in FIG. 3 is carried out using the remote component 14 instead of the vehicular component 12. The remainder of the procedure would be similar to that already described in connection with FIG. 3.

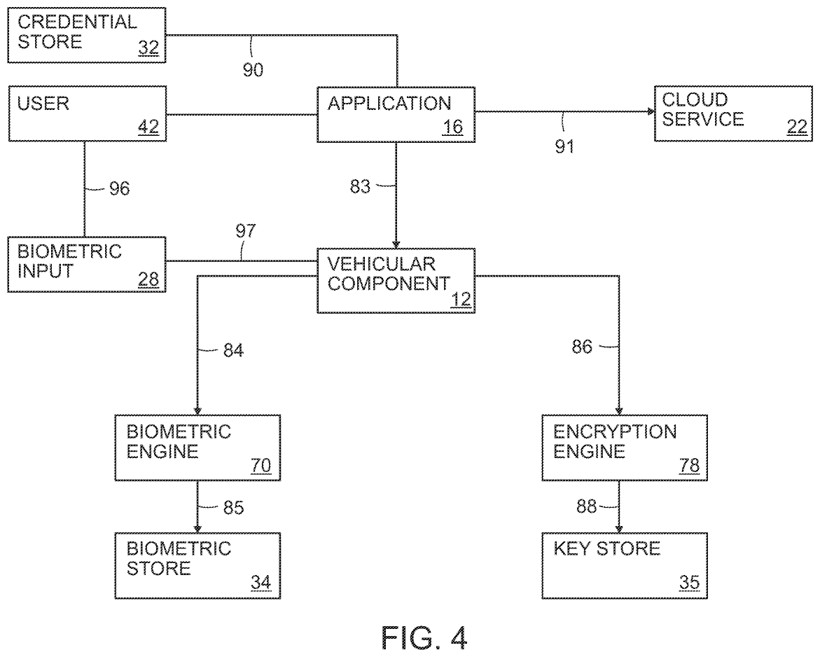

FIG. 4 shows a process in which the application 16 relies on the vehicular component 12 in the process of retrieving user credentials. The process begins with the application 16 issuing a request to the vehicular component 12 to verify the user's identity through biometric authentication (step 83). The biometric input 28 acquires a biometric badge from the purported user 42 (step 96), which then provides it to the vehicular component 12 (step 97). The vehicular component then provides the biometric badge to the biometric engine 70 for authentication (step 84). The biometric engine 70 retrieves a stored biometric badge for that user 42 from the biometric store 34 and matches it with the acquired biometric badge (step 85).

Assuming that biometric authentication was successful, the vehicular component 12 causes the encryption engine 78 to retrieve the user's private key (step 86). The encryption engine 78 then retrieves the private key from the key store 35 (step 88). This private key is now available to the application 16 for use in decrypting the user's credentials, which were stored in encrypted form in the credential store 32 (step 90). The application 16 then uses these credentials to authenticate the transaction with the cloud service 22 (step 91).

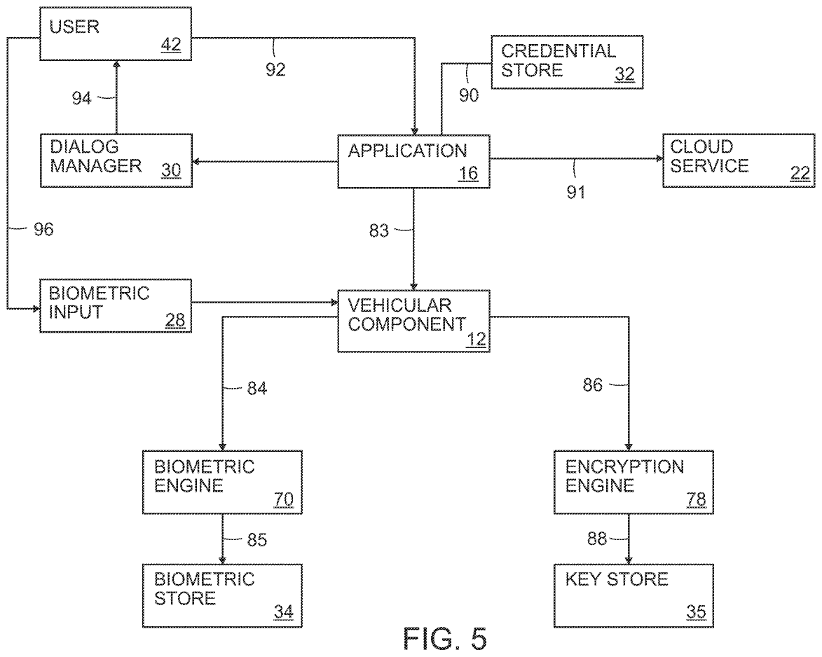

FIG. 5 shows a procedure similar to that shown in FIG. 4 but with the added intercession of the dialog manager 30.

As shown in FIG. 5, the user 42 launches the application 16 (step 92). The application 16 receives information concerning required biometric authorization. The dialog manager 30 prompts the user 42 with dialog calculated to cause the user 42 to provide the relevant biometric information (step 94). The biometric input 28 receives the relevant biometric information (step 96) and provides it to the vehicular component 12 (step 97). The remainder of the procedure is as already discussed in connection with FIG. 4.

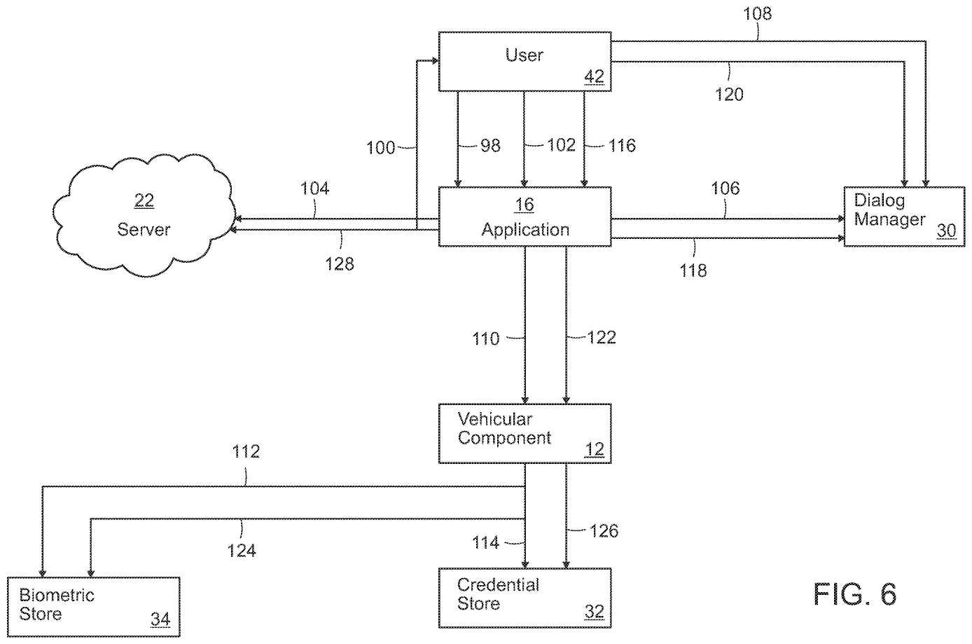

FIG. 6 shows steps carried out when a user 42 who enrolls later attempts to carry out a task.

The process begins with the user 42 initiating the application 16 for the first time (step 98), in response to which the application 16 prompts the user 42 for credentials and also offers to use biometric authentication in future interactions (step 100). The user 42 then provides the credentials to the application 16 and also opts-in for biometric authentication (step 102).

In response, the application 16 communicates with the cloud service 22 to authenticate the user 42 (step 104). It also initiates the dialog manager 30. During an interactive dialog that ensues, the dialog manager 30 instructs the user 42 on steps needed to acquire the relevant biometric information (step 106). The user 42 provides the sought-after biometric information per the dialog manager's instructions (step 108). The application 16 then requests that the user credentials be stored under biometric lock (step 110).

In response, the vehicular component 12 carries out biometric authentication in the manner described in connection with the preceding figures (step 112). After having done so, the vehicular component 12 securely stores the user's credentials with a user key stored in association with the relevant biometric profile for that user 42 (step 114).

At a later time, the user 42 starts the application 16 once again (step 116). Once again, the dialog manager 30 is called upon to provide a dialog that guides the user 42 through the process of providing biometric information (step 118). The user 42 then provides suitable biometric information, for example by uttering a phrase or by presenting a face to a camera (step 120). The application 16 then sends a request to the vehicular component 12 for user credentials (step 122).

Upon receiving the request, the vehicular component 12 carries out the usual biometric authentication procedure already described in connection with preceding figures (step 124) and uses the user key to retrieve the credentials (step 126). These are provided to the application 16, which then uses them in connection with authentication at the cloud service 22 (step 128).

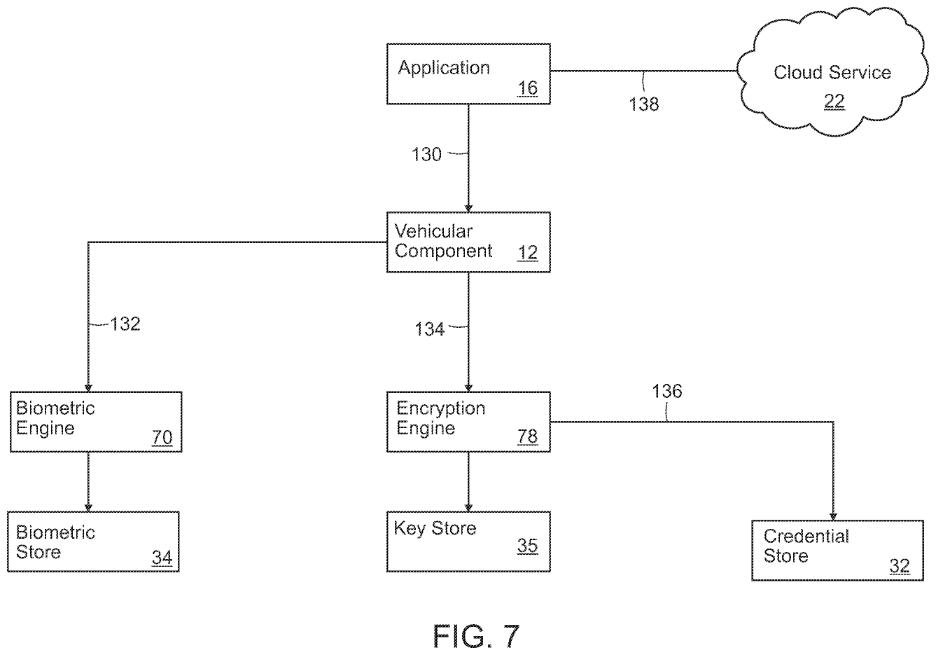

FIG. 7 shows a credential accessing method carried out by the biometric authenticator 10. The method begins with the vehicular component 12 receiving, from the application 16, certain credentials from a user 42, among which is a biometric badge (step 130). The vehicular component 12 carries out biometric authentication in the manner described in connection with the preceding figures (step 132). Assuming success in biometric authentication, the vehicular component 12 proceeds to retrieve the user's private key (step 134) from a key store 35. The private key is then used to decrypt the user credentials (step 136). The application 16 then presents these user credentials to the cloud service 22 for authenticating the user 42 (step 138).

In some cases, the application 16 takes the form of an automotive assistant, in which case the transaction would generally include controlling a feature of the vehicle 20 or of a nearby apparatus configured to receive instructions from the application 16. As such, the transaction would no longer be commercial in nature. An automotive assistant is typically an application that executes on the infotainment system 18 and that understands and executes the user's commands by understanding speech, text, gestures, or combinations thereof.

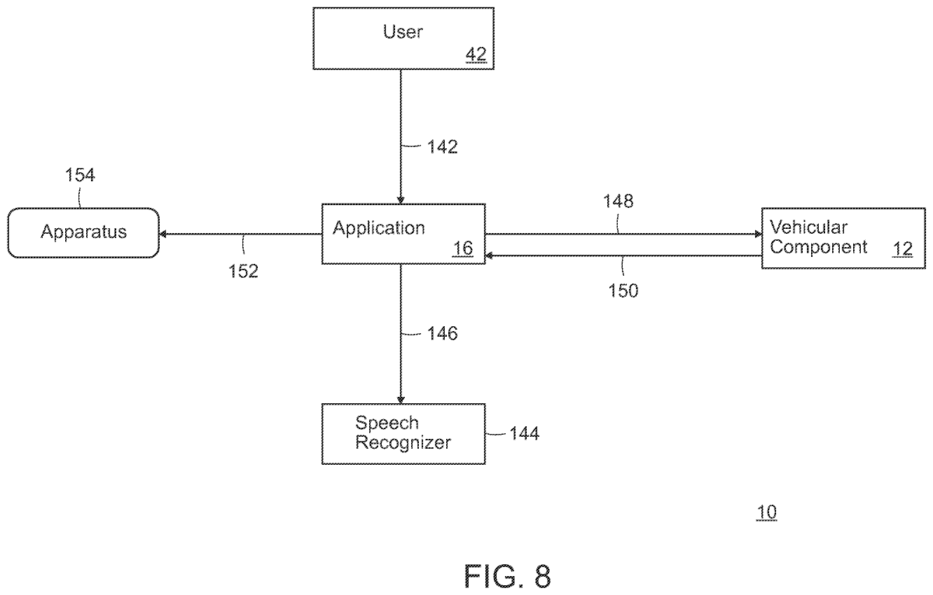

FIG. 8 shows an example of an application 16 that operates as an automotive assistant. After having received an utterance from the user 42 (step 142). An automotive assistant typically sends signals to some other apparatus 154 to cause it to carry out some task. Examples of such an apparatus 154 are devices internal to the vehicle 20, such as a mechanism for rolling a window up or down or a climate control system. Other examples include an apparatus 154 external to the vehicle 20, such as a garage-door opener, in which case the task would be to open the garage door. In such cases, it is not unreasonable to expect some type of authentication would be necessary.

The application 16 provides the utterance to a speech-recognizer 144, which determines the content of the utterance (step 146). Upon learning that the user's intent is to operate an apparatus 154 that requires authentication prior to operation thereof, the application 16 consults the vehicular component 12 to ascertain the correct authentication policy for carrying out the task (step 148). The vehicular component 12 returns the relevant policy (step 150).

Upon recognizing that the authentication policy requires biometric authentication, the application 16 makes an authentication request to the vehicular component 12. Upon receiving information indicating that the biometric authentication was successful, the application 16 transmits a signal to the apparatus 154 to cause it to execute the relevant task, e.g., opening the garage door (step 152).

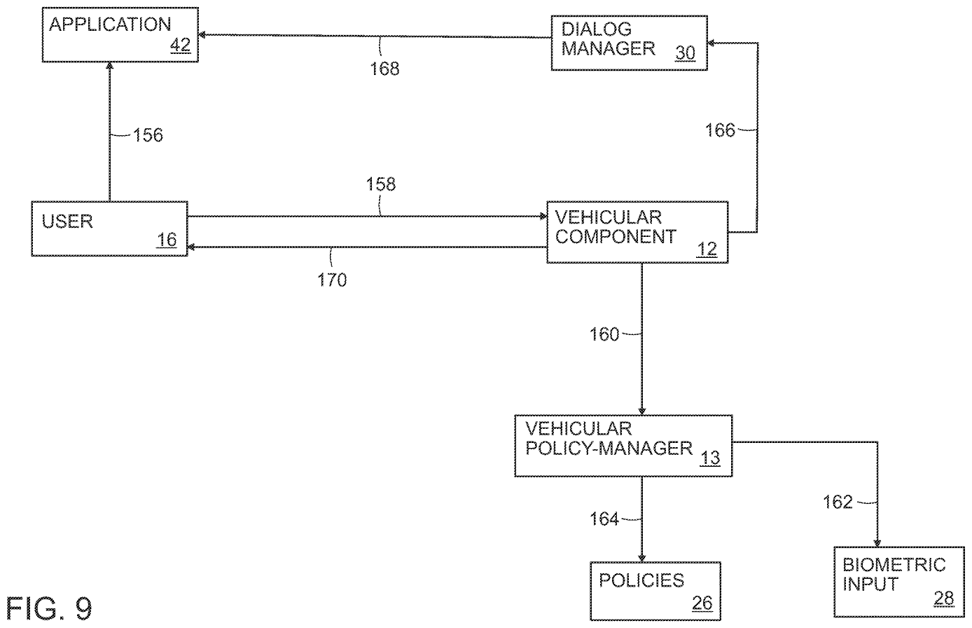

FIG. 9 shows an embodiment in which the user 42 initiates the application 16 (step 156). The application 16 then communicates with the vehicular component 12 to indicate that it has been asked to carry out a particular task (step 158). The vehicular component 12 then requests that a vehicular policy-manager 13 evaluate the relevant policy 26 (step 160). The vehicular policy-manager 13 analyzes the policy 26 based on context information 38 and inspects the available sensors in the biometric input 28 (step 162). It then determines that a modification, such as a step up in authentication or a change in biometric measurements, is required (step 164). The vehicular policy-manager 13 then provides this information to the vehicular component 12, which then instructs the dialog manager 30 to collect the relevant biometric information (step 166). The dialog manager 30 and the user 42 then engage in a dialog that has, as its end result, the collection of the relevant biometric information (step 168). Once this biometric information has been collected, authentication proceeds in the manner already discussed and the application 16 is notified accordingly (step 170).

It is to be understood that the foregoing description is intended to illustrate and not to limit the scope of the invention, which is defined by the scope of the appended claims. Other embodiments are within the scope of the following claims.

What is claimed is:

1. A method for using an application executing on an infotainment system of a vehicle, the method comprising: receiving, from said application, information indicating that an occupant of said vehicle has requested performance of a task, selecting a first policy from a plurality of policies, each of which corresponds to a different task, said first policy defining a first biometric authentication procedure that is specific to said task, generating a second policy based on said first policy, using said second policy, carrying out biometric authentication of said occupant, and based on a result of said biometric authentication, authorizing performance of said task, wherein said second policy defines a second biometric authentication procedure that differs from said first biometric authentication procedure.

2. The method of claim 1, wherein generating said second policy comprises modifying said first policy based on context information, wherein said context information is indicative of a state of said vehicle.

3. The method of claim 1, wherein generating said second policy comprises determining that said first policy requires measurement of a first biometric feature and using a measurement of a second biometric feature in said second policy.

4. The method of claim 1, wherein generating said second policy comprises selecting a biometric feature to rely upon for authentication in said second policy based at least in part on context information indicative of a state of said vehicle.

5. The method of claim 1, wherein said plurality of policies is stored on a remote server.

6. The method of claim 1, wherein said first policy requires biometric authentication using a first method selected from the group consisting of facial recognition and voice recognition and generating said second policy comprises causing said second policy to require biometric authentication using a second method selected from the group consisting of facial recognition and voice recognition, said second method being different from said first method.

7. The method of claim 1, wherein generating said second policy comprises determining that a light level within a cabin of said vehicle is insufficient to use a biometric feature relied upon in said first policy as a basis for said authentication.

8. The method of claim 1, wherein generating said second policy comprises determining that too much noise is present to use a biometric feature relied upon by said first policy.

9. The method of claim 1, wherein generating said second policy comprises selecting a biometric feature to rely upon for authentication in said second policy based on a direction in which said vehicle is traveling.

10. The method of claim 1, wherein generating said second policy comprises selecting a biometric feature to rely upon for authentication in said second policy based on a magnitude of a velocity of said vehicle.

11. The method of claim 1, wherein carrying out biometric authentication of said occupant comprises causing a dialog manager to engage in an interactive dialog with said occupant to guide said occupant in providing biometric information for use in said biometric authentication.

12. The method of claim 1, wherein generating said second policy comprises modifying said first biometric authentication procedure based on having determined that said occupant seeking authentication is a passenger in said vehicle.

13. The method of claim 1, wherein generating said second policy comprises orchestrating sensors in said vehicle to gather different types of biometric information in response to changing circumstances that arise during operation of said vehicle.

14. The method of claim 1, wherein generating said second policy comprises defining a biometric badge for use as a basis for biometric authentication in said second policy, said biometric badge being based on different types of biometric information that have been assigned weights based on context information obtained from sensors in said vehicle.

15. The method of claim 1, wherein generating said second policy comprises defining a dynamically varying biometric badge for use as a basis for biometric authentication in said second policy, said dynamically varying badge being a superposition of different sources of biometric information, wherein said superposition is selected based on context information.

16. The method of claim 1, wherein said task is a transfer of a resource from a first location to a second location.

17. The method of claim 1, wherein said task is to operate a device that is external to said vehicle.

18. The method of claim 1, further comprising receiving, at said remote component, an instruction to modify an authentication policy.

19. The method of claim 1, wherein generating said second policy comprises modifying said first policy based on how many occupants are in said vehicle.

20. The method of claim 1, further comprising maintaining a plurality of authentication policies at said remote component, wherein said policies include policies applicable to only a first fleet of vehicles, policies that are applicable to a second fleet of vehicles, the second fleet being different from said first fleet, policies that are appliable to particular sets of occupants, policies that are applicable only at particular geographic locations and not in others, and policies that are only applicable at some intervals of time and not in others.

21. An apparatus comprising a biometric authenticator that is in data communication with an application executing on an infotainment system of a vehicle, said biometric authenticator comprising a vehicular component that executes on said infotainment system and a remote component that executes on a remote server, wherein said biometric authenticator further comprises a policy store that stores authentication policies, each of which corresponds to a different task, said policies including a first policy that defines a first biometric authentication procedure that is specific to a first task, wherein said biometric authenticator is configured to generate a second policy based on said first policy and to carry out biometric authentication of an occupant of said vehicle, said occupant having requested execution of said first task, wherein said biometric authenticator is further configured to use said second policy to carry out biometric authentication of said occupant and, based on a result of said biometric authentication, to authorize performance of said first task, wherein said second policy defines a second biometric authentication procedure that differs from said first biometric authentication procedure.

22. A method comprising executing first and second instances of an application in infotainment systems of corresponding first and second vehicles, wherein said first and second instances of said application have been requested, by corresponding occupants in said vehicles, to perform corresponding first and second tasks, wherein said first and second tasks are identical, wherein said method further comprises causing said first instance of said application to carry out out a first biometric authentication procedure to authenticate said first occupant and causing said second instance of said application to carry out a second biometric authentication procedure to authenticate said second occupant, said first biometric authentication procedure differing from said second biometric authentication procedure as a result of said first and second vehicles being in different states, said different states giving rise to corresponding differences in context information for said first and second vehicles.
